(19) United States
(12) Patent Application Publication
(10) Pub. No.: US 2016/0031363 A1
(43) Pub. Date: Feb. 4, 2016

(54) Wireless stock trailer light control

(71) Applicant: Raymond Floyd, Cody, WY (US)

(72) Inventor: Raymond Floyd, Cody, WY (US)

(73) Assignee: Raymond Floyd, Cody, WY (US)

(21) Appl. No.: 14/447,135

(22) Filed: Jul. 30, 2014

(51) Int. Cl. B60Q 1/30; B60Q 1/34; B60Q 1/44

(52) U.S. Cl. CPC B60Q 1/305; B60Q 1/44; B60Q 1/34

(57) ABSTRACT

This invention is a wireless link for towed vehicle light and brake control, matching conditions of the towing vehicle. Said conditions include turn signals, brake signals, and running lights. Additionally the signals include an analog signal to provide the towed vehicle electric brake, if installed, a signal proportional to the braking being applied manually or by foot of the towing vehicle operator. The towing vehicle contains signal sensors and conditioners, embedded in an application specific integrated circuit (ASIC) which converts the signals into a modulated signal, and transmits it using a suitable carrier. The towed vehicle contains a receiver and demodulator, which extracts the data which is then passed to the towed vehicle ASIC. The towed vehicle ASIC develops the signals to actuate the appropriate towed vehicle lights. The ASIC also converts the electric brake digital data into an analog signal to apply the proportional signal to the towed vehicle electric brake. The electric brake is applied in proportion to the amplitude of the received signal, to provide a smooth application of the towed vehicle brakes.

### FIELD OF THE INVENTION

This invention relates to a methodology to provide wireless signal lamp and electric brake control for stock trailers and similar towed vehicles.

### BACKGROUND

Historically, stock trailers have used a multi-pin connector on the powered vehicle, connected via a multi-wire cable to the towed vehicle. The number of wires may vary according to the manufacturer of the cable connectors, but most common systems in use today use 5 to 7 wires to conduct signals for electric brakes, turn signals, brake lights, and running lights (including tail lights).

There are a number of problems which can be associated with the current method of signal connection, including; 1) pin retraction on the powered vehicle connector, 2) bent or broken pins on the trailer connector, 3) broken wires on the trailer cable and/or vehicle connector, 4) noisy or poor connections within the vehicle or trailer connector, 5) water and dirt accumulation on either the powered vehicle or towed vehicle connector, and 6) breakage of the cable and/or connector on the towed vehicle side.

Remote control using radio frequency, infrared, acoustics, or similar mediums has been a known technology for a number of years, reference the patents and patent publications reviewed for this document. None of the patents reviewed considered the application of remote control devices as a replacement for the current hard-wired connection used to connect a towing vehicle with a towed vehicle, i.e., a stock trailer, flat-bed trailer, or similar vehicles. Most trailer connections consist of a male and female connector, which can be disconnected and/or connected as necessary to ensure proper operation of the towed vehicle lights and electric brakes.

### SUMMARY OF THE INVENTION

In a preferred embodiment, the present invention is the design and implementation of a wireless communication methodology between a towing and towed vehicle. In the preferred embodiment, the transmission carrier is in the ultrasound range, but could be extended into the UHF range or Infrared range, depending on the implementation. The various lamp conditions of the towing vehicle will be detected, encoded into the appropriate ultrasound frequency, and transmitted to the towed vehicle. The towed vehicle will detect and demodulate the ultrasound frequencies, and set the appropriate signal conditions in the towed vehicle. In addition, if an electric brake is employed, the towed vehicle will apply the brake in an exponential fashion to a pre-set maximum to permit maximum brake pressure without brake lock.

### BRIEF DESCRIPTION OF THE DRAWINGS

FIG. 1 is a general block diagram of the preferred embodiment, showing both the towed and towing vehicle components.

FIG. 2 is a detailed block diagram of the preferred embodiment of the towing vehicle components.

FIG. 3 is a detailed block diagram of the preferred embodiment of the towed vehicle components.

FIG. 4 is a detailed diagram of the byte configurations for towed vehicle light configuration and control.

### DETAILED DESCRIPTION OF THE PREFERRED EMBODIMENT

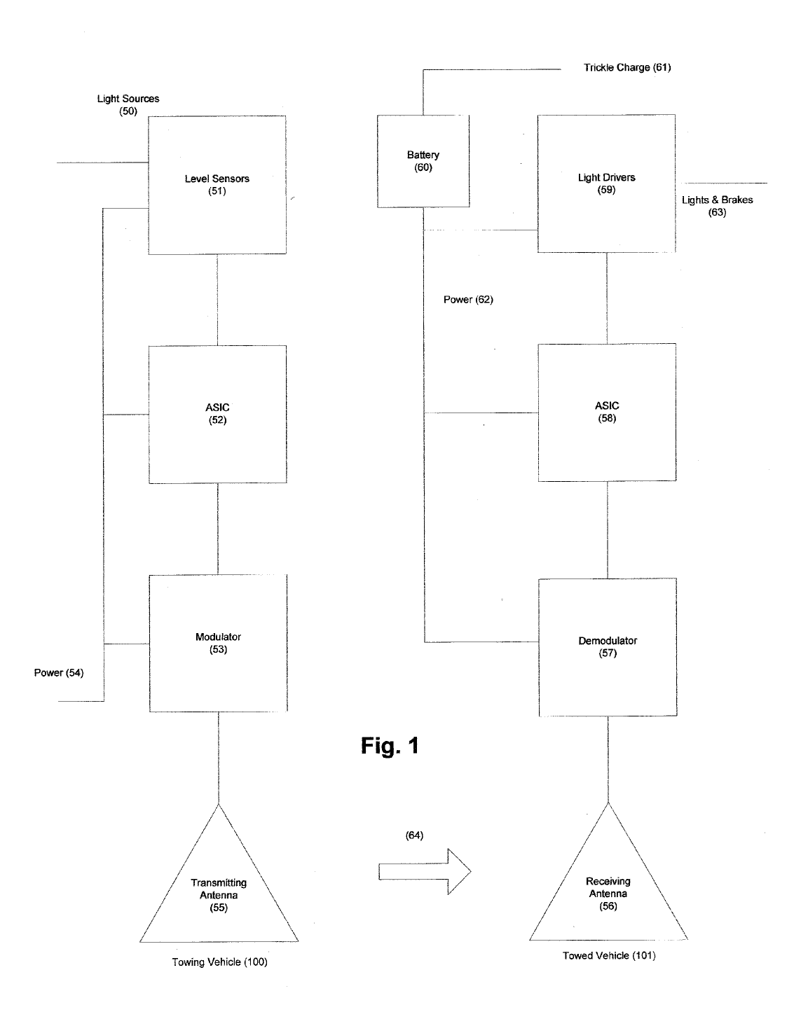

This invention replaces the hard-wired connection between the towing vehicle and towed vehicle with a wireless system to provide the equivalent connections. The wireless system provides a communication link, and can be ultrasonic, infrared, or other suitable medium. A block diagram of the system is provided in FIG. 1.

The towing vehicle 100 has the sensing and transmitting system portion of the remote light control unit. The various light sources 50 are comprised of individual inputs from the right turn signal, the left turn signal, the brake lights, the towing vehicle running lights/head lights, and the trailer brake (if installed). Each light source is detected as being ON or OFF in the Level Sensor (51), or, in the case of the trailer brake, converted from analog to digital signal in the Level Sensor 51 [only one illustrated]. The various light conditions are then fed to the Application Specific Integrated Circuit (ASIC) 52, where the system selects the appropriate tone generator modulator 53 [only one illustrated], where a tone generator is used for each distinct signal to be transmitted. In the event that both the towing vehicle brakes are energized and the electric brake controller is installed, a distinct amplitude modulated tone for the electric brake will be generated for use by the towed vehicle system which will also be used if the electric brake controller is activated by the operator of the towing vehicle independently of the towing vehicle brakes. The tones being activated are passed to the antenna 55, and then transmitted 64 to the towed vehicle receiving antenna 56. Power 54 for the towing vehicle system is derived from the towing vehicle battery system.

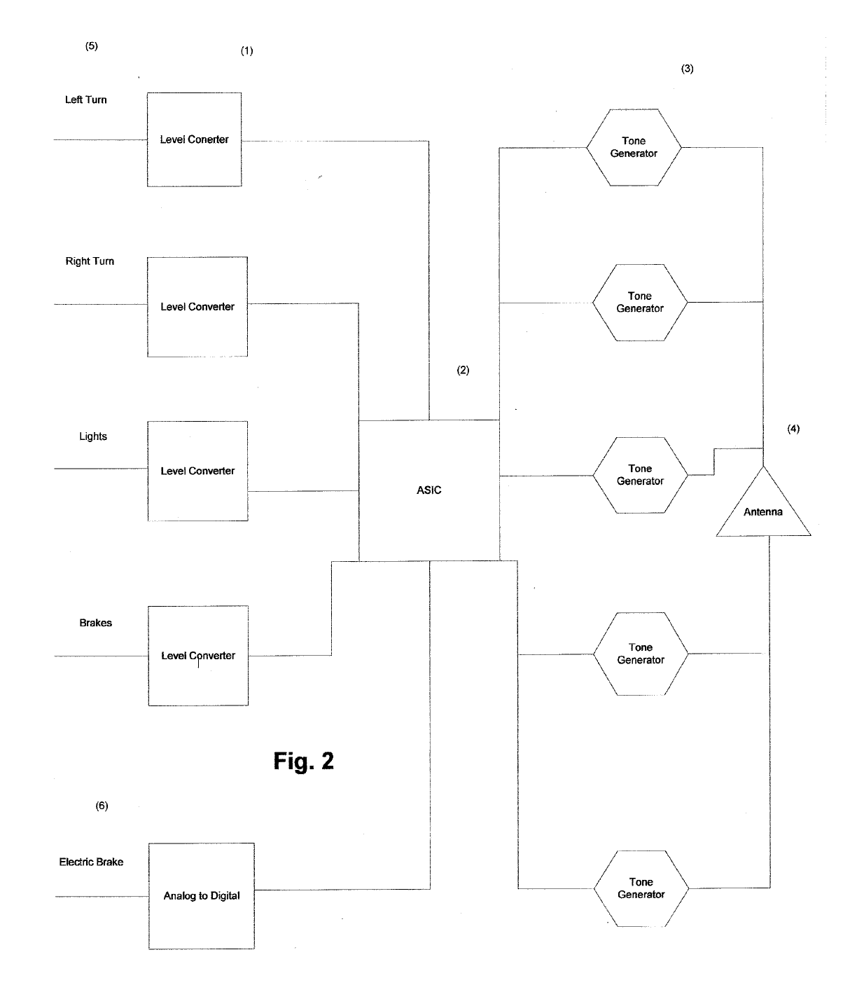

The towed vehicle 101 receives the transmitted signal 64 into the receiving antenna 56 where it is passed to the tone detectors 57 [only one illustrated], where the incoming signal will be decomposed to the constituent frequencies pertinent to the light functions to be completed. The outputs of the tone detectors 57 are passed to an ASIC 58, which will then determine the function(s) to be performed as commanded from the towing vehicle 101. The output of the ASIC 58 will drive light drive circuits 59 [only one illustrated] to cause the particular action to take place 63, i.e. right turn signal on, left turn signal on, brake lights on, and running lights on. The lights will remain on until the particular tone signal associated with that function goes off. The only exception to the drive process concerns the electric brake (if installed). In this case, the ASIC 58 will generate an increasing analog voltage output to apply increasing voltage to the electric brake to increase the brake pressure on the towed vehicle brake system. This braking mechanism will be proportional to the amplitude modulated signal generated by the towing vehicle 100 and will apply a maximum voltage as determined during installation to provide safe braking without locking the electric brake. This braking process will operate when actuated by the towing vehicle brakes or by the towing vehicle operator's manual operation at the electric brake controller. The towed vehicle power 62 is supplied by an on-board battery system 60, which is continuously charged via a trickle charge 61 which may be supplied by any appropriate means (solar panel, wind turbine, towed vehicle axle alternator), or charged by an external AC source when parked [not shown]. The method is not considered part of this application. The towing vehicle system consists of conditioning assemblies, an ASIC, tone generators, and an antenna to broadcast the required control signals, reference FIG. 2. The input signals (left turn, right turn, headlights, brake lights, and electric brake control) 5 are input to level convertors 1, which provide a signal level to the ASIC 2. Based upon the active signal(s), the ASIC 2 will generate an active signal to the respective tone generators 3. The tone generators 3 are sufficiently spaced apart in frequency that multiple tones may be mixed, such as in the case of the brake lights and electric brake controller being active at the same time in normal operation. The output of the tone generators 3 will consist of ultrasound, infrared, or other suitable medium frequencies, and are coupled to the antenna 4 for transmission to the towed vehicle. The tones will be turned on and off based on the signal condition of the system inputs 5.

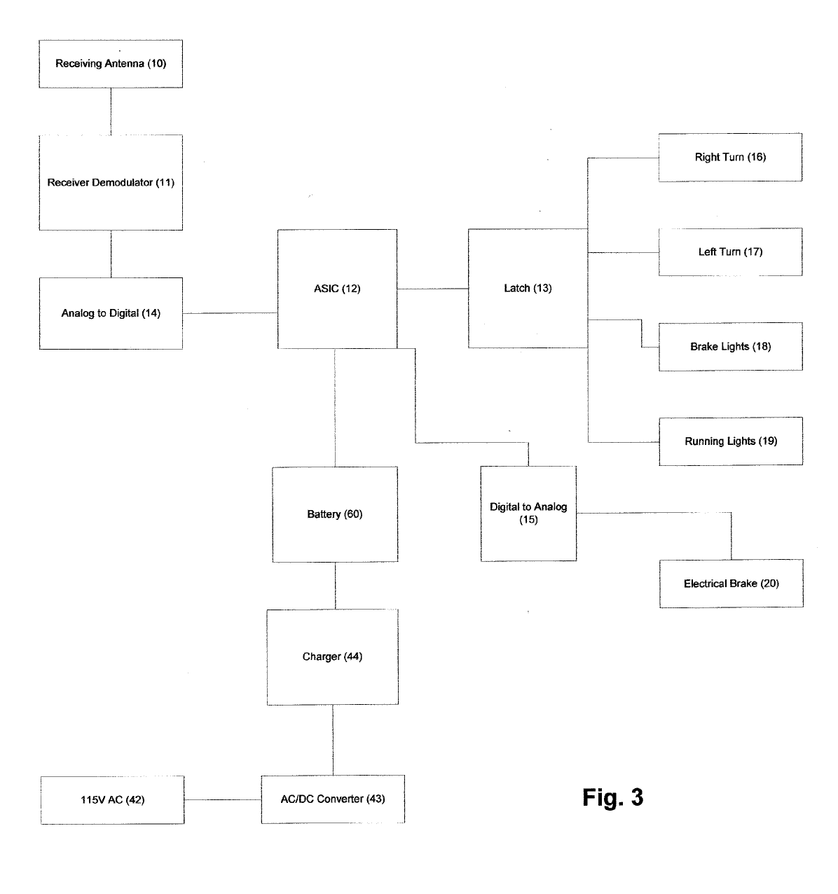

The towed vehicle system consists of an antenna, tone detectors, an ASIC, signal drivers, and a signal conditioner, reference FIG. 3. The signal generated by the towing vehicle is detected and processed by the towed vehicle antenna 10. The output of the antenna 10 is fed to narrow band tone detectors 11 which differentiate the selected tone from the modulated signal. The output of the tone detectors 11 are fed to the ASIC 12, which will determine the activity being commanded. The output from the ASIC 12 is fed to signal latch 13 in the case of turn signals 16 and 17, brake lights 18, and running lights 19, causing the corresponding lights to illuminate. The lights will remain illuminated until the ASIC 12 detects the loss of the output of the respective tone detector 11, at which time the ASIC 12 will issue a reset 13 to the effected signal drive. The exception to the process is the electric brake 20. In this case, the brake is not an on/off system, but an analog signal causing exponentially increasing brake pressure, based on the amplitude of the related incoming demodulator 11. The ASIC 12 will create a digital signal, with a value proportional to the received signal, which will be input to a digital to analog converter 15. The output of the digital to analog converter 15 will become the analog voltage 20 being fed to the towed vehicle's electric brake. This action will be accomplished whether the electric brake signal is originated by the operator applying brakes to the towing vehicle or simply using the electric brake controller handle to apply trailer brakes (without towing vehicle brakes being applied). The towed vehicle uses an on-board battery to provide power to the system (not shown), and can be provided with a trickle charge via a solar panel, wind turbine, or other suitable means self-contained on the towed vehicle. The battery and associated charging methods are not considered part of this application.

In a second embodiment, the proposed system employs an radio frequency (RF) link between the towing vehicle and the towed vehicle. The power of the RF link is less than 1 watt, and operates at a frequency between 300 MHz and 300 THz (UHF to Infared), depending on the system parameters required. It is a line-of-sight system, expected to work across a range of 3 to 8 feet, with dirt, mud, snow, ice, etc. not being a hindrance to proper operation. A block diagram of the system is illustrated in FIG. 1. The towing vehicle unit 100 provides the signal processing 50 and 51, data conversion 52, and RF signal 53, 55, and 64 necessary to communicate the desired signals to the towed vehicle device 101. The inputs to the towing vehicle unit 100 include right turn signal, left turn signal, brake light signal, running lights on signal, electric brake signal 50, and power 54. The output of the towing vehicle unit 100 is a modulated multi-byte data unit, where the first byte is a sync byte, the second is the light conditions to be activated on the trailer, and the third byte has 6 bits of analog value for the setting of the electric brake (if installed). Additional bytes could be added for other functions not yet defined. The modulated signal is transmitted from the towed vehicle unit 100 via the transmitting antenna 55.

The towed vehicle 101 receives the RF signal on its antenna 56, synchronizes with the incoming signal, and then provides outputs to the right turn signal, the left turn signal, the brake lights, the running lights, or an analog signal to the electric brake 63. The output signals, with the exception of the electric brake are latched within the trailer unit as long as the bit is set active in the incoming data string. The trailer unit is powered from a +12V battery 60, which has the charge maintained by a variety of possible sources, including; 1) an optional 12V cable from the powered vehicle, an external trickle charge provided by a solar cell assembly, wind generator, axle alternator or similar power generation device, or an external AC power cord input through a charger controller when the vehicle is stationary. The battery charging system is not considered as part of this application.

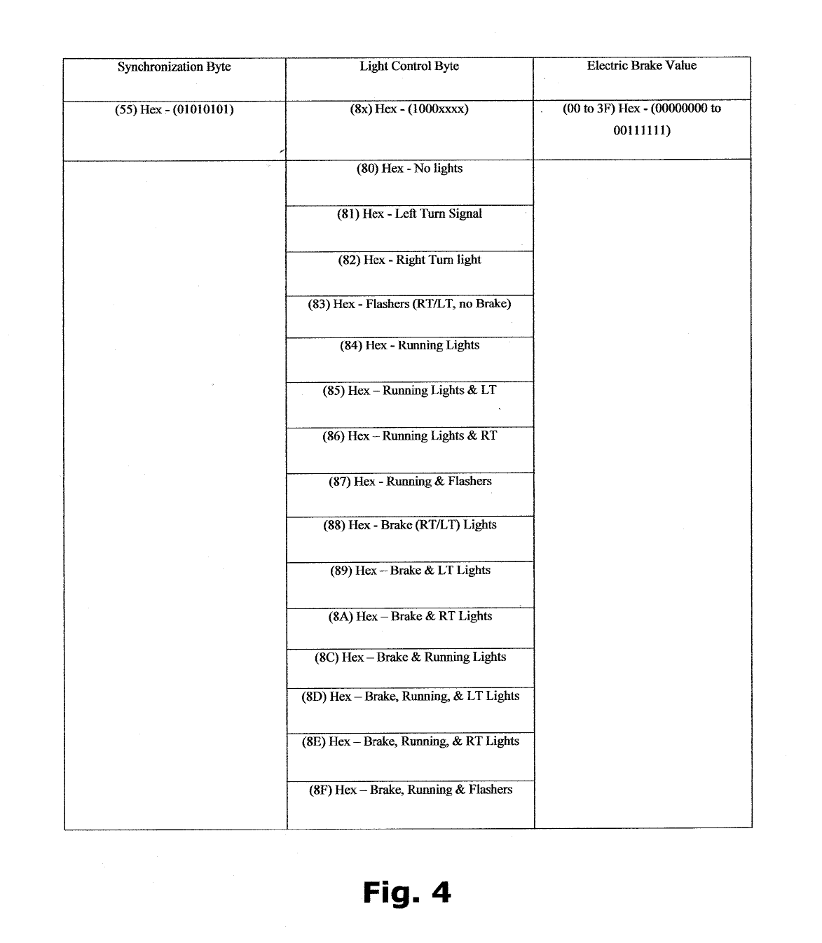

The preferred signal sequence is illustrated in FIG. 4. The first byte of the data string is the synchronization byte, and is set to a hex 55, a unique bit pattern to ensure the towed vehicle is interpreting the incoming command string accurately.

The second byte of the data string, which contains the light pattern (or lights to be energized on the towed vehicle), with bit 0 set to a 1 and the following 3 bits set to 0 (or a hex 8x). Bit 4 will be set to 1 when BRAKE is active, 0 otherwise. Bit 5 will be set to 1 when RUNNING LIGHTS is active, 0 otherwise. Bit 6 will be set to 1 when RIGHT TURN is active, 0 otherwise. Bit 7 will be set to 1 when LEFT TURN is set to 1, 0 otherwise. As some actions, such as emergency flashers, can force conditions where the brake need not be pressed to result in a RT and LT signal illumination, there are codes to allow for these circumstances, and will be controlled by the ASIC. Thus, the permissible byte configurations for the second byte are shown, with the expected action, in FIG. 4.

The third byte contains the analog value to be applied to the electric brake, if installed, on the towed vehicle. The first two bits are set to zero (0), while the remaining 6 bits will take on the value to be applied to the electric brake, thus allowing the brake sensitivity to be divided into a range of unique values.

The RF output of the towing vehicle unit 100 will be a modulated signal containing RF during the time period of a logical 1, or no RF for a logical 0. The three byte data string is repeated every 100 milliseconds, thus ensuring the light activated on the trailer will never be more than 200 milliseconds behind initiation of the signal (100 millisecond maximum delay to ensure synchronization of the two units).

What is claimed is:

1. A wireless light control system for towed vehicles; the system comprising:
a. Towing vehicle light sensors;
b. Towing vehicle signal conditioners;
c. Towing vehicle Application Specific Integrated Circuit (ASIC);
d. Towing vehicle transmitter;
e. Towed vehicle receiver;
f. Towed vehicle Application Specific Integrated Circuit (ASIC);
g. Towed vehicle signal conditioners;
h. Towed vehicle light drivers
i. Towed vehicle analog brake signal generator.

2. The towing vehicle light sensors and signal conditioners of claim 1, wherein the combination conditions and converts the signal for appropriate processing by the ASIC.

3. The towing vehicle ASIC of claim 1, wherein the conditioned light signals are coded into a signal appropriate to the conditions of lights to be processed; the signals comprising:
a. A set of specific tones
b. A specific tone for each light function (turn, brake, running)
c. An amplitude modulated specific tone for the electric brake

4. The towing vehicle ASIC of claim 1, wherein the signal is processed into an ultrasonic signal by the transmitter.

5. The towing vehicle ASIC of claim 1, wherein the encoded signal is processed and transmitted on a continuous basis until the status changes.

6. The towing vehicle ASIC of claim 1 provides electric brake information:
a. As part of the towing vehicle braking action; or
b. As a function of the towing vehicle operator manual brake operation.

7. The towed vehicle receiver of claim 1, wherein the receiver converts the tone signals into digital signals for use by the ASIC.

8. The towed vehicle ASIC of claim 1, which processes the incoming data stream for signal processing.

9. The towed vehicle ASIC of claim 1, which sends appropriate signals to the signal conditioners to activate the selected lights (turn, brake, running).

10. The towed vehicle ASIC of claim 1, which sends an appropriate reset to the signal latches when the activate tone ceases (turn, brake, running).

11. The towed vehicle ASIC of claim 1 will provide an analog signal to the brake signal provided by the towing vehicle for application of the electric brake on the towed vehicle.

12. A wireless light control system for towed vehicles; the system comprising:
a. Towing vehicle light sensors;
b. Towing vehicle signal conditioners;
c. Towing vehicle Application Specific Integrated Circuit (ASIC);
d. Towing vehicle transmitter;
e. Towed vehicle receiver;
f. Towed vehicle Application Specific Integrated Circuit (ASIC);
g. Towed vehicle signal conditioners;
h. Towed vehicle light drivers
i. Towed vehicle analog brake signal generator.

13. The towing vehicle light sensors and signal conditioners of claim 12, wherein the combination conditions and converts the signal for appropriate processing by the ASIC.

14. The towing vehicle ASIC of claim 12, wherein the conditioned light signals are coded into a signal appropriate to the conditions of lights to be processed; the signals comprising:
a. An radio frequency (RF) carrier;
b. A specific modulated signal string encoding light function (turn, brake, running);
c. A specific modulated signal string encoding electric brake control.

15. The towing vehicle ASIC of claim 12, wherein the signal is processed into an RF, infrared, or other suitable signal by the transmitter.

16. The towing vehicle ASIC of claim 12, wherein the encoded signal is processed and transmitted on a regular timed basis.

17. The towing vehicle ASIC of claim 12 provides electric brake information:
a. As part of the towing vehicle braking action; or
b. As a function of the towing vehicle operator manual brake operation.

18. The towed vehicle receiver of claim 12, wherein the receiver converts the RF or Infrared signals into digital signals for use by the ASIC.

19. The towed vehicle ASIC of claim 12, which processes the incoming data stream for signal processing.

20. The towed vehicle ASIC of claim 12, which sends appropriate signals to the signal conditioners to activate the selected lights (turn, brake, running), and an analog signal to the electric brake on the towed vehicle.
